(19) United States
(12) Patent Application Publication
(10) Pub. No.: US 2025/0353681 A1
(43) Pub. Date: Nov. 20, 2025

(54) Transport Vehicle With Lift And Rotate Functionality

(71) Applicant: FlexLink AB, Göteborg (SE)

(72) Inventors: David SHAW, BETHLEHEM, PA (US); Miya FISHER, CRESTVIEW, FL (US); Joe PARISI, SAN JOSE, CA (US); Paul MCELLIN, NORTHAMPTON (GB)

(21) Appl. No.: 18/666,024

(22) Filed: May 16, 2024

(51) Int. Cl. B65G 1/06; B66F 9/12

(52) U.S. Cl. CPC B65G 1/065; B66F 9/12

(57) ABSTRACT

A transport vehicle for use in a production facility is presented. The vehicle includes a support table for carrying material loads that can be lifted and rotated. The vehicle includes an autonomous mobile robot as a base transport unit to which lift and rotate functionalities are provided. The lift functionality is provided by lift control elements of a baseplate assembly fixated to the base transport unit. The rotate functionality is provided by support roller elements of a top plate assembly that is fixated to stability control elements of the baseplate assembly and interacts with the lift control elements. The support table rests on the support roller elements and is rotated via activation of one or more of the support roller elements. When assembled, centers of the top plate assembly and the support table align and coincide with a rotation axis of the support table.

### TECHNICAL FIELD

The present disclosure relates to vehicles, such as autonomous mobile robots, for point-to-point transport of loads/materials in a manufacturing/production and/or warehouse facility.

### BACKGROUND

Autonomous mobile robots (AMRs) have entered the market and offer unique advantages over the more traditional technologies, including, for example, automated guided vehicles (AGVs), used in manufacturing/production and/or storage facilities. In contrast to the traditional (current) technologies, AMRs can learn and adapt to a layout of the facility and use onboard guidance to safely (and autonomously) navigate through the facility, including avoiding of any obstacles. Furthermore, AMRs are typically smaller in size and more maneuverable when compared to the traditional counterparts, making them an ideal choice for deployment in small spaces. AMRs can communicate with a central command unit (e.g., fleet manager) via wireless transmission and accordingly be deployed for specific load/material movements and service multiple pick up and drop off points within the facility. The wireless and onboard guidance capability also allows the vehicle (i.e., AMR) to transit through automated doors and utilize elevators to move between various levels of a building. While deployed, the AMR may follow a deployment route/path as instructed by the central command unit and/or self-determined based on a locally stored facility map. In some cases, the AMR can on the fly optimize the route, including determining a faster and/or alternate route in case a most direct route is blocked or otherwise unavailable and accordingly alert the central command unit. AMRs can also maneuver around personnel and/or obstacles that may partially block the route.

A diagram of an exemplary facility (100) where AMRs may be deployed is shown in FIG. 1. The facility (100) may include various production zones (e.g., Z1, Z2, Z′2, Z3), each such production zone catering, for example, to different aspects and/or functions of the facility, such as, for example, receiving of material required for the production, production/manufacturing/testing of one or more products, packaging and/or storing of the products, and/or shipping of the products.

In some cases, production zones may be situated in different levels of the facility (e.g., building), such as, for example, production zone Z′2 shown in FIG. 1 as accessible via a transit route (T_{NA}, e.g., including elevator, staircase, automatic door, etc.) and situated at a level that may be different than that of production zones (Z1, Z2, Z3). As shown in FIG. 1, each production zone (e.g., Z1, Z2, Z′2, Z3) may include one or more production lines (e.g., stations) to support respective functions of the production zone. For example, shown in FIG. 1 are production lines (Line-A, Line-B, . . . , Line-E) used for implementing respective functions assigned to the production zone Z2.

With continued reference to the facility (100) shown in FIG. 1, the production lines (e.g., Line-A, Line-B, . . . , Line-E) of the production zones (e.g., Z1, Z2, Z′2, Z3) may include respective docks (D_{A}, D_{NA}, shown as circles, e.g., docking locations, docking stations, docking points, loading/unloading points, etc.) for loading and unloading of materials and/or products. As shown in FIG. 1, some of the docks (i.e., D_{A}) may be included, or be part of, a route, T_{A}, that may be accessible to traditional transport vehicles, such as forklifts or AGVs. In other words, such traditional transport vehicles may be able to load and unload materials and/or products to the respective production lines (e.g., Line-A, Line-B, . . . , Line-E) through the accessible docks, D_{A}. On the other hand, some of the docks (i.e., D_{NA}) may not be accessible through the traditional transport vehicles, and therefore not part of the route, T_{A}.

Advantageously and thanks to their reduced form factor and maneuverability, AMRs may be programmed for deployment through otherwise inaccessible routes, including routes that are narrower and/or located at different levels (e.g., Z′2) of the facility (100), to load and unload materials and/or products to the otherwise inaccessible docks, D_{NA}, shown in FIG. 1. Once the AMR reaches a dock (e.g., D_{A}, D_{NA}), the AMR may be required to orient itself to a mating position with the dock (e.g., production line) prior to initiation of a loading or unloading task. To this end, the AMR may include various positional and/or vision sensors (e.g., camera, GPS or other), a support table for the load, and (in some cases) a lift mechanism (e.g., lift table, lift plate, etc.) adapted to vertically move the support table (e.g., up and down).

Present inventors have found that the restriction imposed by the mating position of the AMR relative to the dock in combination with a single degree of freedom in motion/position of the support table may limit flexibility of the current state of the art AMRs and/or impose added capabilities to the production lines used in a facility in order to compensate for the limitations of such AMRs.

It follows that teachings according to the present disclosure describe an AMR with added flexibility in motion of the support table while maintaining all of the currently available features. In turn, such added flexibility may allow relaxing of production lines capabilities/requirements with benefits such as reduction in space allocation and cost.

### SUMMARY

Applicant has found that currently used autonomous mobile robots (AMRs) in a production facility may be restricted to a single degree of freedom in motion/position of the support table as provided by a lift mechanism fitted to the AMRs. While such AMR can turn and steer via its wheels to change a direction of the support table and therefore of a load carries by the support table, such change in direction may lack precision and require a greater turning radius as the entire vehicle is required to turn. Furthermore, because the entire vehicle is required to turn, such change in direction, and therefore orientation, of the vehicle, may not be possible when the vehicle is required to be positioned at a specific orientation for mating with a production line (e.g., dock).

In particular, Applicant has found that lack of rotational capability of the support table of present-day AMRs has forced production facilities to design costly and larger equipment for interface with such AMRs.

For example, Applicant has noted that current automation material loading/unloading processes such as, for example, palletizing/depalletizing, in a production facility may require larger robot systems that include robot arms having a longer reach for loading/unloading of the materials in the entire palletizing work envelope (e.g., surface area of a pallet).

As a further example, Applicant has noted that current stretch wrapping stations require a large turntable to rotate a loaded pallet that may be charged onto the turntable via a forklift. Disadvantages associated with operation and implementation of such stretch wrapping stations may include added cost for charging/discharging of the loaded pallets onto/from the AMR, including, for example, added cost for a forklift and/or associated operator, or of an associated conveyor and queuing mechanism. Further added cost may include cost associated with acquisition and operation of the large turntable as well cost related to added footprint/space/area of the facility.

Such shortcomings have motivated Applicant to provide for an additional degree of freedom in motion/position of the support table of an AMR, and therefore of a corresponding load, via a rotation mechanism coupled to the support table for precise control of rotation of the support table.

Applicant envisions that rotational control of the support table may enable new applications to develop such as smaller footprint (loading) palletizing or (unloading) depalletizing, side transfer of material/loads on and off the AMR, and various pallet orientation options for acquiring and releasing of the pallet (e.g., load).

Applicant envisions that rotational control of the support table may further enable new machine-to-machine interfaces such as small footprint stretch wrapping, labelling of units of loads on multiple sides with a single applicator, and corner post applications to name a few. In turn, the small footprint of such machine-to-machine interfaces may enable new areas of automation previously not possible due to facilities space limitations and relatively large space requirements of traditional automated pallet handling technologies.

As an example, Applicant envisions use of an AMR with a rotating support table as a means to, for example, eliminating the bulk of the present-day wrapping station equipment and support, including the associated large turntable, conveyor and queuing mechanism, forklift and/or operator. Applicant envisions a new type of small footprint stretch wrapping stations where transport of a loaded pallet to proximity of a wrapping film mechanism and application of the wrapping film onto the loaded pallet may be provided by the AMR with a rotating support table.

As another example, Applicant envisions a rotating support table that may be lifted and/or rotated independently from an orientation of the AMR and independently from a stationary or moving state of the vehicle. Applicant envisions use of such added flexibility not only during steps directly related to loading and/or unloading of material/pallets to and/or from the support table, but also during the transport of a loaded AMR between stations of the production facility, where, for example, the support table may be rotated during the transport, and while moving, for presenting of a smaller profile of the loaded AMR allowing passage through a narrow spacing of a travel path.

Applicant envisions an item transport vehicle that according to the various aspects of the present disclosure is provided by adapting of a lifting and rotating support table mechanism to a base transport unit.

In particular, in a first aspect, the present disclosure relates to an item transport vehicle that includes a base transport unit that preferably includes an autonomous mobile robot (AMR). Advantageously, the base transport unit may be a generic AMR unit, such as a readily available off the shelf or custom-built AMR unit, configured for wireless communication with a central command unit and fitted with onboard guidance (e.g., via embedded controller and sensors) to safely navigate through a production facility.

Preferably, the item transport vehicle includes lift control elements arranged on the AMR. Advantageously, the lift control elements are configured to provide a vertical motion/position.

Preferably, the item transport vehicle includes support elements arranged on the AMR. Advantageously, the support elements are rotating elements that allow rotation and angular position.

Preferably, the item transport vehicle includes a support table resting on the support elements. Accordingly, the lift control elements allow raising and/or lowering of the support table, and the support elements allow rotation of the support table, including control of an angular position of the support table.

According to a second aspect, the present disclosure relates to an upgrade kit that includes the lifting and rotating support table mechanism, the upgrade kit designed to interface with a target transport vehicle that provides functionality of an autonomous mobile robot.

Preferably, the upgrade kit for the transport vehicle includes lift control elements configured to provide a vertical motion/position.

Preferably, the upgrade kit for the transport vehicle includes support elements configured to provide rotation and angular position.

Preferably, the upgrade kit for the transport vehicle includes a support table resting on the support elements. Accordingly, the lift control elements allow raising and/or lowering of the support table, and the support elements allow rotation of the support table, including control of an angular position of the support table.

According to a third aspect, the present disclosure relates to a method for loading and wrapping items.

Preferably, the method comprises the step of providing an item transport vehicle comprising an autonomous mobile robot, lift control elements and support elements arranged atop the autonomous mobile robot, and a support table that rests on the support elements.

Preferably, at an item loading station, the method comprises the steps of a) activating the lift control elements to control a vertical position of the support table by raising and/or lowering the support table, and/or b) activating the support elements to control an angular position of the support table by rotating the support table, to load items on the support table.

Preferably, the method comprises the step deploying the item transport vehicle from the item loading station to a stretch wrapping applicator station.

Preferably, at the stretch wrapping applicator station, the method comprises the step of activating the support elements to control a rotation speed of the support table, thereby stretch wrapping a film from the stretch wrapping applicator station around the items on the support table.

In this way it is possible to make the transport vehicle an active participant in the stretch wrapping process, including, deployment proximate a wrapping film mechanism and rotation of the support table for application of the wrapping film onto a loaded pallet.

According to a fourth aspect, the present disclosure relates to a method for loading and/or unloading items.

Preferably, the method comprises the step of providing an item transport vehicle comprising an autonomous mobile robot, lift control elements and support elements arranged atop the autonomous mobile robot, and a support table that rests on the support elements.

Preferably, at an item loading and/or unloading station, the method comprises the steps of a) optionally activating the lift control elements to control a vertical position of the support table by raising and/or lowering the support table, and b) activating the support elements to control an angular position of the support table by rotating the support table, to load and/or unload items on the support table optionally via a robotic arm of the item loading and/or unloading station.

In this way it is possible for a smaller and more compact robot system having a reduced reach to deposit and/or collect the items over the entire palletizing work envelope, thereby saving space and reducing cost.

According to a fifth aspect, the present disclosure relates to a method for transporting items between stations.

Preferably, the method comprises the step of providing an item transport vehicle comprising an autonomous mobile robot, lift control elements and support elements arranged atop the autonomous mobile robot, and a support table that rests on the support elements.

Preferably, at a first station, the method comprises the step of loading items on the support table.

Preferably, the method comprises the step of transporting, via the item transport vehicle, loaded items to a second station through a transport path.

Preferably, during the transporting, the method comprises the step of activating the support elements to control an angular position of the support table, thereby presenting a smaller profile of the loaded items.

The present disclosure, in at least one of the aforesaid aspects, may have at least one of the further preferred features set out below.

In a preferred embodiment, the item transport vehicle comprises stability control elements arranged atop the autonomous mobile robot, the stability control elements configured to stabilize a radial position of the support elements.

In this way, a relevant safety feature of the item transport vehicle according to the present disclosure is provided. Such stability control allows vertical and/or rotation movements of the support table even when the support table is loaded. Advantageously, stabilizing of the radial position of the support elements in turn allows preventing side-to-side or front-to-back movement of the support table, even with unbalanced or off-center loads.

In a preferred embodiment, the item transport vehicle comprises a baseplate, with the lift control elements mounted on the base plate.

In a preferred embodiment, the item transport vehicle comprises a top plate, with the support elements mounted on a top plate.

Preferably, the top plate is coupled to the base plate via the stability control elements, the stability control elements restricting a relative motion of the top plate relative to the base plate to a vertical motion provided by the lift control elements.

In a preferred embodiment, each of the stability control elements comprises a top block, a bottom block, a top arm, and a bottom arm, the top block and the bottom block respectively fixated to the top plate and the base plate.

In some embodiments, respective first ends of the top arm and the bottom arm are coupled to one another through a center pivot point, and respective second ends of the top arm and the bottom arm respectively coupled to the top block and the bottom block through respective top and bottom pivot points.

Accordingly, and advantageously, any movement of the top block, bottom block, top arm, and bottom arm of each of the stability control elements may be restricted to within a plane that is orthogonal to the rotation axes of the respective pivot points.

Preferably, for each of the stability control elements, respective rotation axes of the center, top and bottom pivot points are according to a same direction, and arrangement of the stability control elements on the base plate is configured to provide at least two different directions of the respective rotation axes.

Accordingly, and advantageously, a relative movement between the base plate and the top plate may be restricted to a vertical movement and therefore devoid of any side-to-side (or front-to-back) movement. Structural rigidity provided by the stability control elements may in turn allow safeguarding of such restricted (vertical) movement even in case of unbalanced or off-centered (pallet) loads.

Preferably, each of the lift control elements comprises a vertical lift structure coupled to a respective lift drive.

In some embodiments, the vertical lift structure is fixated on the base plate.

In some embodiments, the vertical lift structure comprises a scissors mechanism coupled to the respective lift drive via a leadscrew.

Accordingly, and advantageously, when not driven, the vertical lift structure can rigidly maintain its vertical position, even under load.

In some embodiments, the support elements are mounted through openings formed in the top plate.

Preferably, the openings are formed according to locations of a circle centered about a center axis of the support table.

Preferably, respective centers of the base plate and top plate coincide with the center axis of the support table.

Preferably, during operation of the transport vehicle, the base plate and the top plate remain parallel.

Advantageously, the above operation rendered possible, in part, thanks to the stability control elements.

Preferably, during operation of the transport vehicle, the support table remains substantially parallel to, and at a fixed distance from, the top plate.

Advantageously, the above operation rendered possible, in part, thanks to the support table resting on the support elements.

Preferably, during operation of the transport vehicle, the top plate moves vertically relative to the base plate.

Advantageously, the above operation rendered possible, in part, thanks to the stability control elements and under control of the lift control elements.

In a preferred embodiment, each of the support elements is configured to rotate about a respective rotation axis that intersects the center axis of the support table.

Accordingly, and advantageously, efficient coupling of rotation forces from the support elements to the support table can be provided irrespective of a load.

In a preferred embodiment, said transport vehicle comprises at least one rotation drive for driving of at least one of the support elements, the at least one rotation drive mounted on a bottom surface of the top plate.

Accordingly, and advantageously, a reduced number of rotation drives can be used for provision of a reduced form factor driving mechanism.

In some embodiments, the at least one rotation drive is coupled to the at least one support element via a belt.

Such belt, including for example a chain, can advantageously provide a simple and low-cost technique for efficiently coupling of a rotational force produced by the at least one rotation drive to the at least one support element.

In some embodiments, the at least one rotation drive includes a DC motor, a stepper motor, or a variable speed motor.

This allows for provision of a precise angular position and/or rotation control of the support table and/or flexibility in generation of rotation speed profiles applied to the support table.

Preferably, the support table is coupled to the top plate via a bearing having a center that coincides with a center axis of the support table.

Advantageously, the bearing can further prevent side-to-side movement of the support table. Furthermore, the bearing and support roller elements maintain a consistent offset (e.g., distance) between the support table and the top plate assembly for any load within design tolerances that is applied on the support table, thereby creating an operational gap that prevents interference with a rotation of the support table.

In some embodiments, all of the support elements are actively driven support elements.

In some alternative embodiments, the support elements include at least one actively driven support element and at least one passive support element that is not actively driven.

This allows the at least one actively driven support element to rotate the support table via a friction force, and the at least one passive support element that freely rotates, to guide a rotation of the support table.

In a preferred embodiment, said upgrade kit for a transport vehicle comprises stability control elements configured to stabilize a radial position of the support elements.

In this way, a relevant safety feature of the upgrade kit according to the present disclosure is provided. Such stability control allows vertical and/or rotation movements of the support table that rests on the support elements even when the support table is loaded. Advantageously, stabilizing of the radial position of the support elements in turn allow preventing side-to-side or front-to-back movement of the support table, even with unbalanced or off-center loads.

In a preferred embodiment, the upgrade kit for the transport vehicle comprises a base plate, with the lift control elements mounted on the baseplate.

In a preferred embodiment, the upgrade kit for the transport vehicle comprises a top plate, with the support elements mounted on the top plate.

Preferably, the top plate is coupled to the base plate via the stability control elements, the stability control elements restricting a relative motion of the top plate relative to the base plate to a vertical motion provided by the lift control elements.

In a preferred embodiment, said upgrade kit is configured to be mounted atop a readily available autonomous mobile robot via a matching profile of the base plate, and communicate with the autonomous mobile robot via control electronics included in the upgrade kit.

In this way, the upgrade kit can be manufactured/assembled at one location and later installed/mounted onto the readily available autonomous mobile robot at another location.

In some embodiments, said method for loading and wrapping items, comprises, at the item loading station, the step of activating a brake of the item transport vehicle, thereby maintaining a fixed position and orientation of the item transport vehicle during loading of the items.

Advantageously, this allows for increased stability and position accuracy during the loading of the items.

In some embodiments, said method comprises, at the stretch wrapping applicator station, the step of activating a brake of the item transport vehicle, thereby maintaining a fixed position and orientation of the item transport vehicle during the application of the stretch wrapping film.

Advantageously, this allows for increased stability and position accuracy during the application of the stretch wrapping film.

In some embodiments, said method comprises, based on the control of the angular position of the support table at the item loading station, the steps of setting the support table to a first angular position and to a second angular position.

In some embodiments, said method comprises, at the first angular position, loading a first portion of the items on the support table, and at the second angular position, loading a second portion of the items on the support table.

In this way it is possible for a smaller and more compact robot system having a reduced reach to deposit the items over the entire palletizing work envelope, thereby saving space and reducing cost.

In some embodiments, said method comprises, based on the control of the rotation speed of the support table at the stretch wrapping applicator station, the step of continuously rotating the support table according to a rotation speed profile.

In this way it is possible to control a rotation speed and a number of revolutions of the support table for uniform application of the wrapping film around the loaded support table. The rotation speed profile may take into consideration any potential increase and/or decrease in resistance presented by the loaded support table as the wrapping progresses. Such profile and/or the number of revolutions of the support table may further take into consideration, for example, total weight of the loaded pallet and/or distribution of unit loads across the width and/or height of the loaded pallet.

In some embodiments, said method comprises, at the stretch wrapping applicator station and prior to the stretch wrapping of the film, the step of applying corner posts around the items loaded on the support table.

In some embodiments, said step for applying the corner posts comprising the steps of positioning the item transport vehicle near a corner post applicator station, rotating the support table in sequence, thereby sequentially setting respective angular positions of the support table, and at each of the respective angular positions, applying a respective corner post around the items loaded on the support table.

In this way, advantageously providing added strength of the loaded and stretch wrapped pallet via the applied corner posts.

In some embodiments, said method for loading and/or unloading items, comprises, at the item loading and/or unloading station, the step of c) further activating the support elements to further control an angular position of the support table by further rotating the support table, to load and/or unload further items on the support table via the robotic arm of the item loading and/or unloading station.

In this way it is possible for an even smaller and more compact robot system having a more reduced reach to deposit and/or collect the items over the entire palletizing work envelope, thereby further saving space and reducing cost. Flexibility in the control of the angular position can provide benefit of partitioning of the palletizing work envelope into smaller effective work envelopes reachable by the compact robot system.

In some embodiments, the transport path of said method for transporting items between stations, includes a narrow spacing, and said smaller profile is for passing through the narrow spacing.

In this way, if the transport path includes a narrow spacing, then the support table is rotated such as to present the smaller profile of the loaded items for passing through the narrow spacing.

Accordingly, it is possible to deploy the transport vehicle through otherwise inaccessible travel/transport paths/routes that include narrow spacings corresponding to, for example, access doors and/or elevators.

In some embodiments of said method, the activating of the support elements is performed while the item transport vehicle travels/moves through the transport path.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a diagram of an exemplary production facility.

FIG. 2A shows a perspective view of an autonomous mobile robot (AMR) according to an embodiment of the present disclosure.

FIG. 2B shows a side view of the AMR of FIG. 2A carrying a load.

FIG. 2C shows a top view of the AMR of FIG. 2A carrying a load that is rotated.

FIG. 2D shows a side view of the AMR of FIG. 2A mated to a loading/unloading dock.

FIG. 3A shows a diagram of a baseplate assembly of the AMR of FIG. 2A.

FIG. 3B shows a perspective view of a stabilizer assembly according to an embodiment of the present disclosure.

FIG. 4A shows an exploded view of a top plate assembly and a support table of the AMR of FIG. 2A.

FIG. 4B shows a diagram of the baseplate assembly, top plate assembly and support table in an assembled configuration.

FIG. 5A shows a diagram of a prior art stretch wrapping station.

FIG. 5B shows a loaded pallet ready for stretch wrapping.

FIG. 6A and FIG. 6B show a machine-to-machine interface according to an embodiment of the present disclosure for use in the production facility of FIG. 1

Like reference numbers and designations in the various drawings indicate like elements.

### DETAILED DESCRIPTION

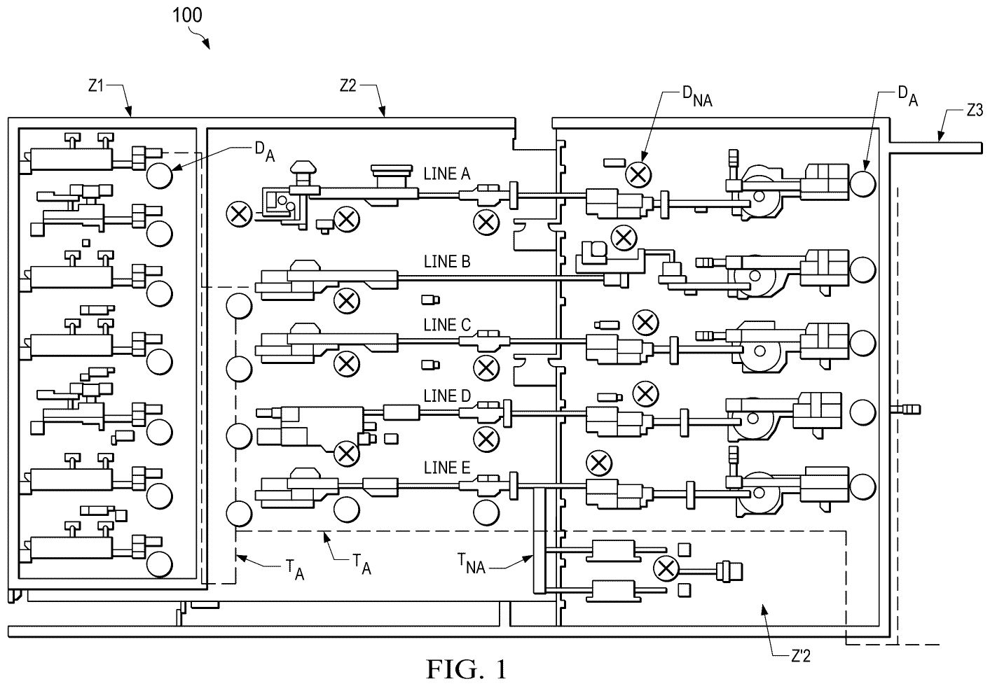

As described above, currently used autonomous mobile robots (AMRs) in a production facility (e.g., 100 of FIG. 1) may be restricted to a single degree of freedom in motion/position of the support table as provided by a lift mechanism fitted to the AMRs. While a base transport unit (e.g., base AMR) of an AMR can turn via its wheels (e.g., steer) to change a direction of the support table and therefore of a load, such change in direction may lack precision and require a greater turning radius as the entire vehicle (e.g., AMR) is required to turn. Furthermore, because the entire vehicle is required to turn, such change in direction, and therefore orientation, of the vehicle, may not be possible when the vehicle is required to be positioned at a specific orientation for mating with a production line (e.g., dock).

Teachings according to the present disclosure provide for an additional degree of freedom in motion/position of the support table of an AMR, and therefore of a corresponding load, via a rotation mechanism coupled to the support table for precise control of rotation of the support table. Accordingly, the support table of the present disclosure may be characterized as a rotating support table that may be lifted and/or rotated independently from an orientation of the vehicle (AMR) and independently from a stationary or moving state of the vehicle.

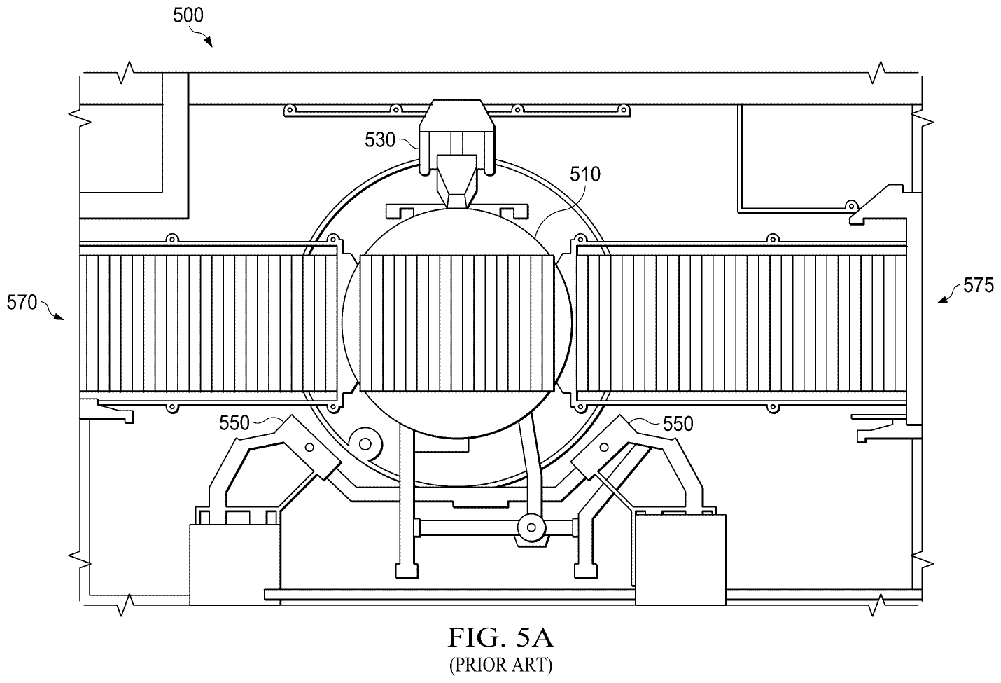

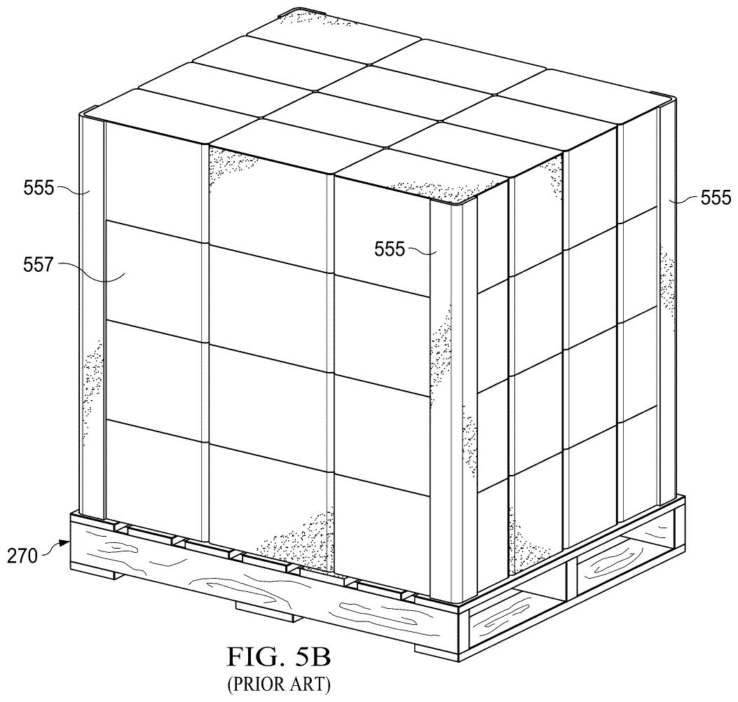

Rotational control of the support table according to the present teachings may enable new applications to develop such as smaller footprint (loading) palletizing or (unloading) depalletizing, side transfer of material/loads on and off the AMR, and various pallet orientation options for acquiring and releasing of the pallet (e.g., load) and/or for presenting of smaller profiles of the loaded AMR for passage through a narrow spacing of a travel path. Rotational control of the support table according to the present teachings may further enable new machine-to-machine interfaces such as small footprint stretch wrapping, labelling of units of loads (e.g., 557 of FIG. 5B later described) on multiple sides with a single applicator, and corner post applications (e.g., 555 of FIG. 5B later described) to name a few. In turn, the small footprint of such machine-to-machine interfaces may enable new areas of automation previously not possible due to facilities space limitations and relatively large space requirements of traditional automated pallet handling technologies.

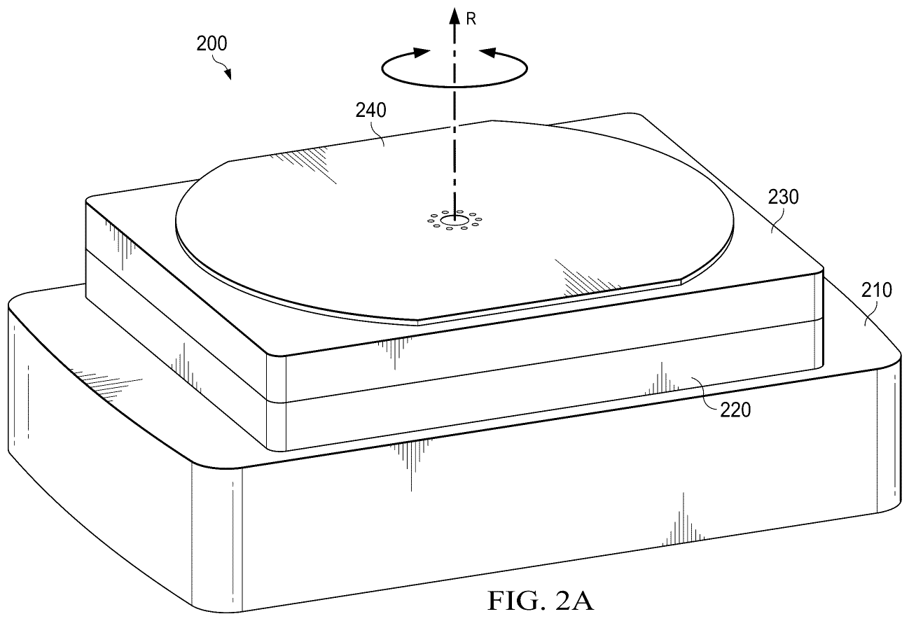

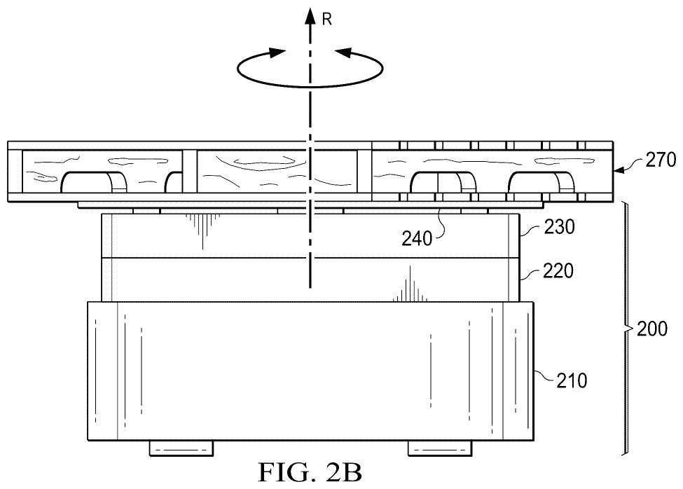

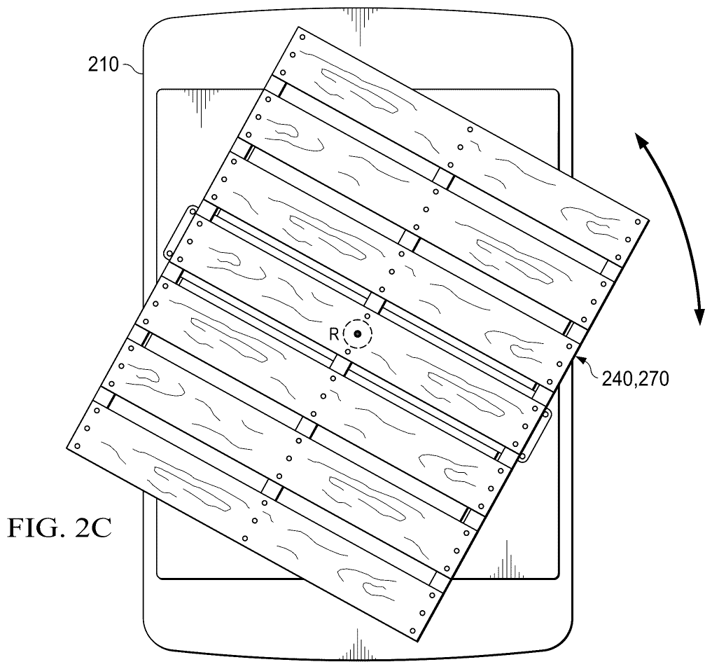

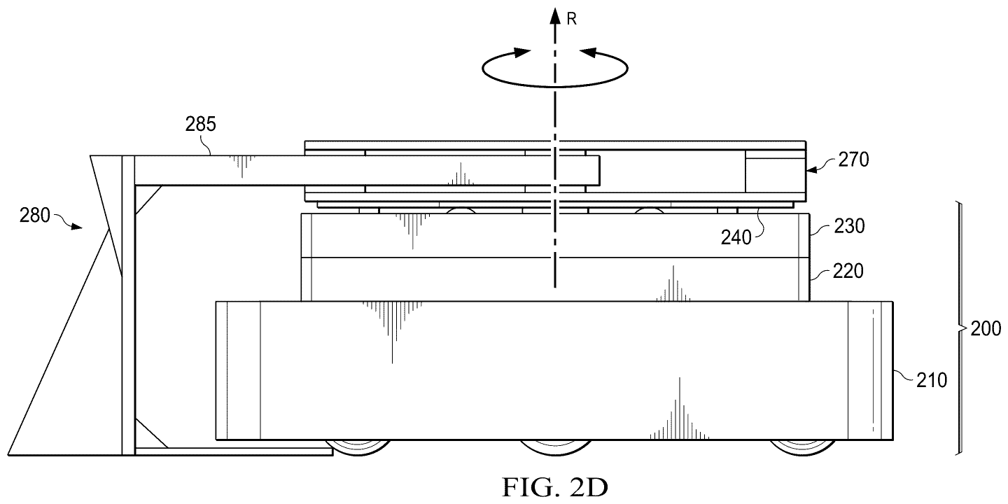

FIG. 2A shows a perspective view of an autonomous mobile robot (AMR, 200) according to an embodiment of the present disclosure. The AMR (200) includes a base transport unit (210), a baseplate assembly (220) mounted on, or coupled to, the base transport unit (210), a top plate assembly (230) mounted on, or coupled to, the baseplate assembly (220), and a support table (240) mounted on, or coupled to, the top plate assembly (230). As will be described later in the present disclosure, mounting or coupling between the elements shown in FIG. 2A may be provided via a combination of mechanical fasteners (e.g., screws, bolts, nuts, etc.), bearings and/or friction.

With continued reference to FIG. 2A, the base transport unit (210) may be a generic AMR unit, such as a readily available off the shelf or custom-built AMR unit, configured for wireless communication with a central command unit and fitted with onboard guidance (e.g., via embedded controller and sensors) to safely navigate through a production facility. The base transport unit (210) may be fitted with interface electronics to communicate with (elements of) the baseplate assembly (220) and/or the top plate assembly (230). Various wired or wireless communication standards may be envisioned for such interface.

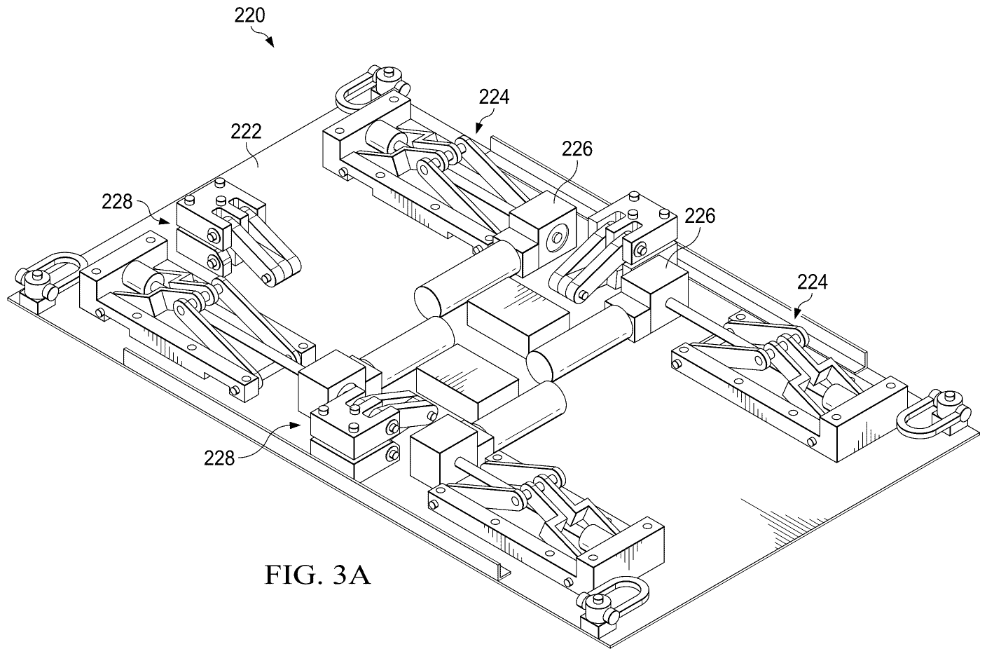

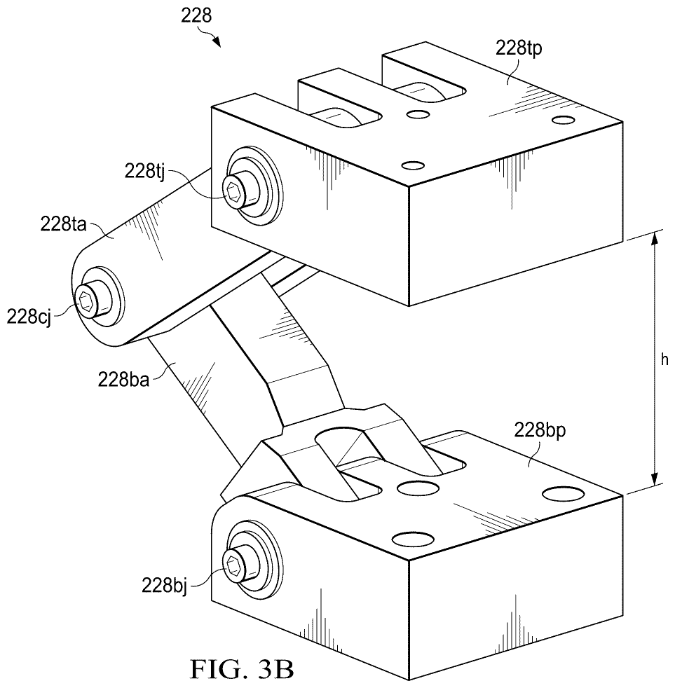

The baseplate assembly (220) shown in FIG. 2A may be made to mate with the top surface/footprint of the base transport unit (210) and include lift control elements (e.g., 224, 226 of FIG. 3A later described) enabling vertical motion/position of the combination of the top plate assembly (230) and support table (240). According to an embodiment of the present disclosure, the baseplate assembly (220) may further include stability control elements (e.g., 228 of FIG. 3A later described) for stability control of the combination of the top plate assembly (230) and support table (240) when carrying a load. The stability control elements may prevent any side-to-side or front-to-back movement (e.g., motion) or rotational movement of the top plate assembly (230) and keep the baseplate assembly (220, e.g., base plate 222 of FIG. 3A later described) and the top plate assembly (230) parallel to each other even with unbalanced or off-centered (pallet) loads. Further details of the baseplate assembly (220) and corresponding lift control and stability control elements is provided in the below description with reference to, e.g., FIG. 3A and FIG. 3B.

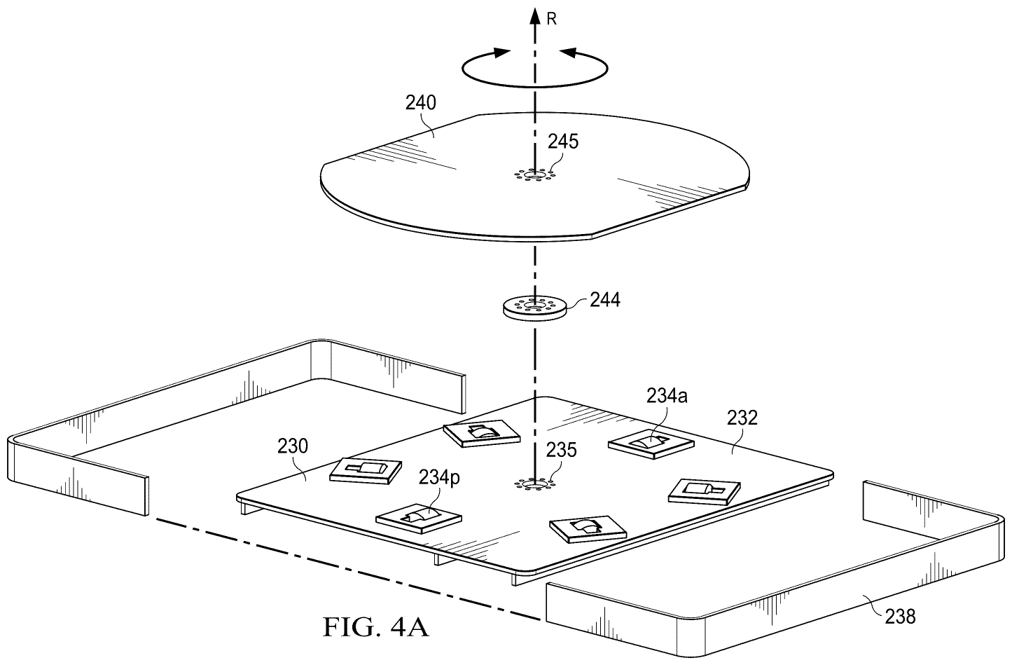

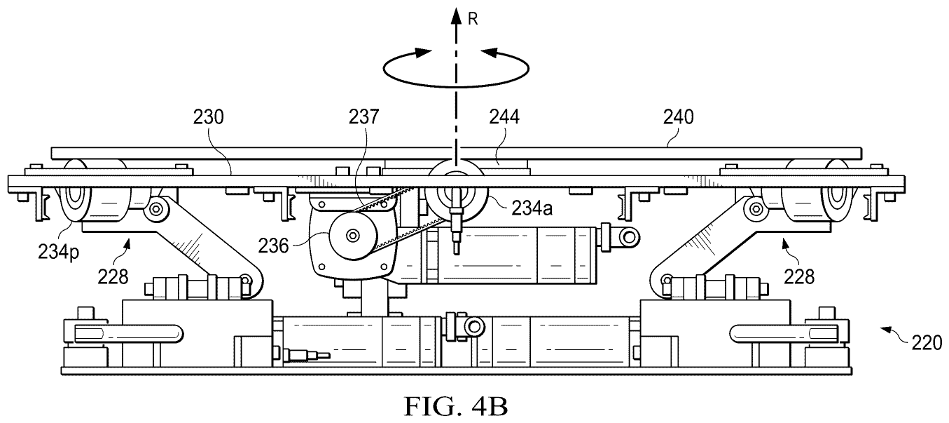

The top plate assembly (230) may be mounted on or coupled to the stability control elements of the baseplate assembly (220) and include support roller elements (e.g., 234a, 234p of FIG. 4A later described, a.k.a. support elements or rotating support elements) configured to support and facilitate rotation of the support table (240) about a rotation axis, R. According to an embodiment of the present disclosure, one or more, including all, of the support roller elements may be active (e.g., driven, powered) support roller elements configured to couple a rotational force to the support table (240). According to an embodiment of the present disclosure, one or more of the support roller elements may be passive (e.g., not active, free spinning/rotating) support roller elements configured to guide a rotation of the support table (240) according to the coupled rotational force. Further details of the top plate assembly (230) and corresponding support roller elements is provided in the below description with reference to, e.g., FIG. 4A and FIG. 4B.

It should be noted that the combination of the baseplate assembly (220), top plate assembly (230) and support table (240) may be configured as one assembly adapted to fit on and communicate with a readily available base transport unit (210, e.g., a basic AMR) for provision of lift and rotation capabilities. In other words, the assembly (220, 230, 240) may be envisioned as an upgrade kit tailored to a specific form factor and communication interface of a readily available base transport unit.

FIG. 2B shows a side view of the AMR (200) of FIG. 2A carrying a pallet (270, e.g., load). As shown in FIG. 2B, the pallet (270) may be centrally arranged on the support table (240). Central arrangement may be with reference to a center axis of the AMR (200) that may coincide with the rotation axis, R. Although the pallet (270) may be centrally arranged on the support table (240), a material loaded onto the pallet (270) may not necessarily include a center gravity that coincides with the center axis (i.e., rotation axis R) as the stability control elements may compensate for any resulting weight imbalance. Such weight imbalance compensation provided by the AMR (200) according to the present teachings can in turn facilitate safe and stable rotation of the support table (240) under load. Accordingly, the support table (240) under load may be safely rotated during a stationary state and/or a moving state (e.g., including steering) of the AMR (200). Rotation of the support table (240) carrying the pallet (270) about the rotation axis, R, is shown in FIG. 2C.

The AMR (200) according to the present disclosure may interface with operators and materials (e.g., production lines). The provided lift and rotate functionalities may allow the AMR (200) to position itself to a first docking location (e.g., any of D_{A} or D_{NA} of FIG. 1) to acquire (e.g., load) a pallet or material cart and transport it to a second docking location to deliver (e.g., unload) the pallet or material cart with added flexibility in position control (i.e., lift and rotate) of the support table (240). Such added flexibility in position control of the support table (240) may allow the pallet or material cart to be acquired or delivered based on any desired vertical and/or rotational (e.g., angular) position of the support table (240) while maintaining a desired (e.g., fixed) orientation of the base transport unit (210). Furthermore, during the transport, a lower profile of the pallet or material cart may be provided by rotating the support table (240) to allow passage through a narrow spacing. Such rotation may be provided either by first stopping the AMR (200) to obtain a stationary state of the AMR (200) or by maintaining a moving state (e.g., including steering) of the AMR (200).

With continued reference to FIG. 2C, the added flexibility in position control (i.e., lift and rotate) of the AMR (200) according to the present disclosure may allow, for example, the AMR (200) to position/orient itself to a docking location (e.g., any of D_{A} or D_{NA} of FIG. 1) of a conveyor system used in a production line (e.g., Line-A, Line-B, . . . , Line-E of FIG. 1) of a production facility (e.g., 100 of FIG. 1), rotate the pallet or material cart (e.g., 270 of FIG. 2C) according to a desired rotational position while maintaining the position/orientation of the AMR (200, e.g., 210), and lower and/or raise the pallet or material cart to deposit it, for example, on a pair of fixed (inactive) edge conveyors which are subsequently activated to transfer the material cart onto a roller or drag chain type (moving) conveyor (belt).

It should be noted that the AMR (200) according to the present disclosure may be used for transporting of any material that may be loaded directly or indirectly onto the support table (240). In some cases, the material may include a same item or various items of differing shapes. In some cases, such material may be provided as unit loads, each unit load comprising one or more units of the material. In some cases, the unit loads may be placed into containers of same or differing sizes. In some cases, the containers may be material carts (e.g., open container, bin) or boxes (e.g., closed container, 557 of FIG. 5B later described). The material, unit loads, or containers may be loaded directly onto the support table (240) or onto a pallet (e.g., 270 of FIG. 2C) placed atop the support table (240).

The added flexibility in position control (i.e., lift and rotate) of the AMR (200) according to the present disclosure may further allow a reduction in production equipment and associated cost. For example, current automation of the palletizing (e.g., material loading) process in a production facility (e.g., 100 of FIG. 1) may require larger robot systems to provide a longer reach (e.g., via respective robot arms) for depositing of the materials in the entire palletizing work envelope (e.g., surface area of a pallet). However, because the support table of the AMR (200) according to the present teachings can rotate the pallet (270) while it is being loaded, a smaller and more compact robot system with reduced reach can deposit the materials (e.g., unit loads) over the entire palletizing work envelope, thereby saving space and reducing cost.

On the other hand, as shown in FIG. 2D, the AMR (200) according to the present disclosure may deposit the pallet (270) on an arm/support (285) of a stationary structure (280) of a production line (e.g., a warehouse rack system), thereby maintaining the ability available in the present-day technology.

FIG. 3A shows a diagram of the baseplate assembly (220) of the AMR of FIG. 2A. According to an embodiment of the present disclosure, the baseplate assembly (220) includes a (substantially flat, planar) base plate (222) that is designed to fit/mate and mounted (e.g., fixated, fastened, etc.) to the top (surface) of the base transport unit (210). The baseplate assembly (220) further includes lift control elements (224, 226) mounted (e.g., fixated, fastened, etc.) to the base plate (222), and stability control elements (228) mounted (e.g., fixated, fastened, etc.) to the base plate (222). It should be noted that only elements essential to the present disclosure are herewith described. A person skilled in the art would clearly realize that the baseplate assembly (220) may include other elements not shown/described in the present disclosure. These may include, for example, electronic modules/controllers/transceivers (e.g., control and interface electronics), power supplies/drivers, sensors (e.g., proximity, level, etc.), and/or wiring harness adapted for communication (e.g., receive commands and/or transmit status) and/or interface with the base transport unit (210) and/or the top plate assembly (230).

With continued reference to FIG. 3A, according to an embodiment of the present disclosure, the lift control elements (224, 226) may be arranged symmetrically about a center of the base plate (222). In the assembled configuration of the AMR (200), the center of the base plate (222) may be aligned (e.g., collocated, coincide) with the rotation axis, R, described above with reference to, e.g., FIG. 2A. According to an exemplary embodiment of the present disclosure, the baseplate assembly (220) may include four lift control elements (224, 226). Other implementations including a different number of lift control elements (224, 226), including 3, 5 or greater may be envisioned.

According to an exemplary embodiment of the present disclosure, the base plate (222) is of a substantially rectangular (e.g., including square) shape and the lift control elements (224, 226) are arranged along (e.g., close to) edges that define sides of the rectangular shape. According to an exemplary embodiment of the present disclosure and as shown in FIG. 3A, the rectangular shape includes a two oppositely arranged longer sides (e.g., extensions) and two oppositely arranged shorter sides, and the lift control elements (224, 226) are arranged in pairs along the two oppositely arranged longer sides.

With continued reference to FIG. 3A, each lift control element (224, 226) includes a vertical lift structure (224, e.g., device) coupled to a respective lift drive (226, e.g., actuator). When driven by the lift drive (226), the vertical lift structure (224) establishes/controls the vertical position of the top plate assembly (230), and therefore of the support table (240). Driving (e.g., actuation) of the vertical lift structure (224) may be provided through a screw mechanism (e.g., a leadscrew) for conversion of, e.g., a rotation provided by the lift drive (226) to a vertical translation provided by the vertical lift structure (224). When not driven, the vertical lift structure (224) may rigidly maintain its vertical position, even under load. According to some nonlimiting embodiments of the present disclosure, when under load (i.e., material loaded onto the support table 240), the support table (240) may be lowered to its lowest vertical position for increased stability during motion (e.g., travel) of the AMR (200). It should be noted that in some applications, lowering and/or raising of the support table (240) under load during a rotation of the support table (240) and/or during a motion of the AMR (200) may be envisioned.

According to a nonlimiting embodiment of the present disclosure, the vertical lift structure (224) of FIG. 3A may include a known in the art scissors mechanism. Other known in the art mechanisms for the vertical lift structure (224) may be envisioned, based on, for example, a desired maximum load capacity of the AMR (200). According to an embodiment of the present disclosure, the lift drive (226) may include a (rotating) motor, including, for example, a DC motor, such as, for example, a stepper motor. It should be noted that the lift drive (226) may include other types of (electrical to mechanical) actuators based on design goals and performances of the AMR (e.g., position accuracy, vertical lift mechanism, and/or maximum load capacity).

FIG. 3B shows a perspective view of the stabilizer assembly (228) that may be used as one of the stability control elements (228) of the baseplate assembly (220). As described above in the present disclosure, teachings according to the present disclosure may use three or more stability control elements (228, e.g., stabilizer assembly) to prevent the top plate assembly (230), and therefore the support table (240), from moving in any direction but vertical. Accordingly, the stability control elements (228) may prevent any side-to-side or front-to-back motion or rotational motion of the top plate assembly (230) and keep the baseplate assembly (220, e.g., base plate 222 of FIG. 3A) and the top plate assembly (230) parallel to each other even with unbalanced or off centered (pallet) loads.

With continued reference to FIG. 3B, the stabilizer assembly (228) may include a top plate (228tp), a bottom plate (228bp), a top arm (228ta) and a bottom arm (228ba). As shown in FIG. 3B, respective first ends of the top arm (228ta) and the bottom arm (228ba) may be coupled to one another through a center pivot point (228cj, e.g., joint), and respective second ends of the top arm (228ta) and the bottom arm (228ba) may be respectively coupled to the top plate (228tp) and the bottom plate (228bp) through respective top and bottom pivot point (228tj) and (228bj). Because the pivot points/joints (228bj, 228cj, 228tj) allow rotation about rotation axes that are parallel (and therefore according to a same direction), then any movement of the top plate (228tp), bottom plate (228bp), top arm (228ta), and bottom arm (228ba) of the stabilizer assembly (228) may be restricted to within a plane that is orthogonal to the rotation axes of said pivot points.

It follows that by using a plurality of the stabilizer assemblies (228), such as three or more, that as shown in FIG. 3A may be arranged (oriented) to provide respective (pivot points) rotation axes that may not be parallel (e.g., according to at least two different, such as, e.g., orthogonal, directions), and attaching (e.g., fixating, fastening, etc.) the respective bottom plates (228bp) and top plates (228tp) of the stabilizer assemblies (228) respectively to the base plate (222 of FIG. 3A) and the top plate assembly (230, e.g., as shown in FIG. 4A later described), then a relative movement between the baseplate assembly (220) and the top plate assembly (230) may be restricted to a vertical movement (e.g., h of FIG. 3B) and therefore devoid of any side-to-side (or front-to-back) movement. Structural rigidity provided by the stabilizer assemblies (228) may allow safeguarding of such restricted (vertical) movement even in case of unbalanced or off centered (pallet) loads. In some embodiments according to the present disclosure, the top plate (228tp) and bottom plate (228bp) of the stabilizer assembly (228) may include substantially flat surfaces for attaching to the base plate (222) and the top plate assembly (230).

FIG. 4A shows an exploded view of the top plate assembly (230) and support table (240) of the AMR (200) of FIG. 2A, and FIG. 4B shows a diagram of the baseplate assembly (220), top plate assembly (230) and support table (240) of the AMR (200) of FIG. 2A in an assembled configuration. According to an embodiment of the present disclosure, the top plate assembly (230) includes a (substantially flat, planar) top-support plate (232) that is designed to be coupled to the baseplate assembly (220) via the stability control elements (228). In other words, as described above with reference to, e.g., FIG. 3B, and shown in the diagram of FIG. 4B, the top plate (228tp) of the stability control elements (228) attaches to (the bottom surface/underside, of) the top-support plate (232).

As shown in FIG. 4A, the top-support plate (232) of the top plate assembly (230) may include a substantially rectangular (e.g., including square) shape with dimensions commensurate to the dimensions of the base plate (222) of the baseplate assembly (220). Formed in the top-support plate (232), there may be a plurality of radially arranged openings for arrangement of respective support roller elements (234a, 234p). In the assembled configuration of the AMR (200), and as shown for example in FIG. 4B, the center of the top-support plate (232) may be aligned (e.g., collocated, coincide) with the rotation axis, R, described above with reference to, e.g., FIG. 2A.

According to an exemplary embodiment of the present disclosure, and as shown in FIG. 4A, the support roller elements (234a, 234p) may be radially and symmetrically arranged about the center of the top-support plate (232). According to an exemplary embodiment of the present disclosure, the support roller elements (234a, 234p) may be arranged radially about the center of the top-support plate (232) according to a locus (e.g., angularly distanced points) provided by a circle centered at the center of the top-support plate (232). According to an exemplary embodiment of the present disclosure, respective rotation axes of the support roller elements (234a, 234p) may intersect at the center of the top-support plate (232), and therefore the center axis, R. It should be noted that because the stability control elements (228) may prevent any side-to-side or front-to-back movement or rotational movement of the top plate assembly (230), and keep the baseplate assembly (220) and the top plate assembly (230) parallel to each other, then it can be said that the stability control elements (228) may stabilize respective radial positions of the support roller elements (234a, 234p), and therefore stabilize (e.g., coincide) a position of the rotation axis, R, of the support table (240), with respect to the center axis of the baseplate assembly (220).

Other elements included in (or attached to) the top-support plate (232) may include rotation drives (e.g., 236 of FIG. 4B, attached on the lower surface (e.g., underside) of the top-support plate 232) that may couple to respective (powered, active) support roller elements (234a). It should be noted that only elements essential to the present disclosure are herewith described. A person skilled in the art would clearly realize that the top plate assembly (220) may include other elements not shown/described in the present disclosure. These may include, for example, sensors (e.g., proximity, level, etc.), and/or wiring harness adapted for communication (e.g., receive commands and/or transmit status) and/or interface with the base transport unit (210) and/or the baseplate assembly (220).

According to an embodiment of the present disclosure, the support roller elements (234a, 234p) of FIGS. 4A/4B may include one or more active (e.g., driven, powered) support roller elements (234a) that may be activated via respective rotation drives (236, e.g., actuators) and one or more passive (e.g., not active) support roller elements (234p). According to an exemplary embodiment of the present disclosure, the top plate assembly (230) may include at least three (i.e., three or more) support roller elements (234a, 234p). According to an exemplary embodiment of the present disclosure, the top plate assembly (230) may include exclusively active support roller elements (234a). According to an exemplary embodiment of the present disclosure, the top plate assembly (230) may include a single active support roller element (234a) and two or more passive support roller elements (234p). A person skilled in the art would realize that a choice for a number of active and/or passive support roller elements (234a, 234p) for a target AMR may be based on design goals and performances.

Each support roller element (234a) or (234p) may include at least one roller (wheel, e.g., of same dimension across all the elements 234a, 234p) that is configured to contact and support the support table (240, e.g., substantially parallel to the top-support plate 232). As shown in FIG. 4B, the support table (240) may rest (e.g., with substantially equipartitioned weight) on all the support roller elements (234a, 234p), thereby providing a stable surface for resting of a (e.g., loaded) pallet. Furthermore, a resulting friction force (at a contact surface) between the support roller elements (234a, 234p) and the support table (240) may in turn cause a controlled rotation of the support table (240) according to a rotation speed of the one or more active support roller elements (234a).

According to a nonlimiting exemplary embodiment of the present disclosure, and as shown in FIG. 4B, coupling of a rotational force generated by a rotation drive (236) to a respective active support roller element (234a) may be provided via a belt (237, e.g., or chain). According to an embodiment of the present disclosure, the rotation drive (236) may include, for example, a DC motor, such as, for example, a stepper motor. Such stepper motor may allow precise angular position/rotation of the support table (240). Optical sensors and/or proximity switches may be used to determine/detect an angular position of the support table (240) with respect to the top plate assembly (230), and therefore with respect to the baseplate assembly (220) and the base transport unit (210). In some embodiments according to the present disclosure, such angular position may be referenced, for example, to a zero degrees angular position where the support table (240) is aligned with the underlying assemblies (e.g., 210, 220, 230) as shown for example, in FIG. 2A. According to an exemplary embodiment of the present disclosure, the rotation drive (236) may include a variable speed drive/motor such to control a rate/speed of rotation of the one or more active support roller elements (234a) and therefore of the support table (240). Advantageously, such variable speed drive may allow flexibility in generation of rotation speed profiles applied to the support table (240).

As shown in FIG. 4A, the support table (240) may be flat, or substantially flat (e.g., planar), with a center region that is designed to interface and be aligned with a bearing (244). It should be noted that although a shape of the support table (240) may be considered a design choice, dimensions (e.g., geometry) of the support table (240) may be commensurate to the dimensions of the top plate assembly (230) in view, for example, of the (radial) position/location of the support roller elements (234a, 234p). According to an exemplary nonlimiting embodiment of the present disclosure, the shape of the support table (240) may be any one of a rectangular, square, quadrilateral, multilateral with more than three sides, round, oval, or other. According to an exemplary nonlimiting embodiment of the present disclosure, and as shown in FIG. 4A, the shape of the support table (240) may be a disco-rectangle, or in other words, a rectangle with the shorter sides replaced by curves/arcs or semicircles (e.g., stadium shape). Such disco-rectangle shape may include a width, that as also shown in, e.g., FIG. 2A, may be substantially equal to (or smaller than) a width of the baseplate assembly (220) and/or top plate assembly (230). Such width may in turn allow a reduced/smaller profile of the AMR (200) during deployment/transit of the device.

According to an embodiment of the present disclosure, the bearing (244) may be attached/fixated to the center of the top plate assembly (e.g., plate 232) via a plurality of mounting holes (235). According to an embodiment of the present disclosure, the plurality of mounting holes (235) may be contained within a recess formed in the center region of the top-support plate (232), the bearing (244) being arranged within the recess. According to an embodiment of the present disclosure, the support table (240) may be attached/fixated to the bearing (244) via a plurality of mounting holes (245) formed in a center region of the support table (240). According to a preferred embodiment of the present disclosure, the bearing (244) may be a high-load face-mount crossed-roller bearing that may allow handling of radial, thrust, and moment (twisting) loads that may be exerted via a loaded support table (240). As shown in FIGS. 4A/4B, in the assembled configuration of the AMR (200), the centers of the top-support plate (232, e.g., 230) and of the support table (240) may be aligned (e.g., collocated, coincide) with the rotation axis, R, described above with reference to, e.g., FIG. 2A.

Use of the bearing (244) in the AMR (200) according to the present teachings may advantageously prevent any side-to-side movement of the support table (240) that rests on the support roller elements (234a, 234p). Furthermore, the bearing (244) and support roller elements (234a, 234p) may maintain a consistent offset (e.g., distance) between the support table (240) and the top plate assembly (230) for any load (e.g., within design tolerances) applied on the support table (240), thereby creating an operational gap that prevents interference with a rotation of the support table (240). Furthermore, as shown in FIG. 4A, safety guards (238) that may surround the baseplate assembly (220) and/or the top plate assembly (230) may be used to prevent access to the rotating/moving parts and/or potential pinch points of such assemblies.

FIG. 5A shows a diagram of a prior art stretch wrapping station (500) that is traditionally used for stretch wrapping of loaded pallets. The prior art stretch wrapping station (500) includes a (powered) turntable (510), a film (e.g., wrapping film/sheet/material) applicator (530), a pair of corner post applicators (550), a pallet in-feed (e.g., charge) terminal (570), and a pallet out-feed (e.g., discharge) terminal (575). Loaded pallets may be provided/queued into the in-feed terminal (570) and transported via, e.g., a conveyor mechanism or a forklift, onto the turntable (510) for processing by the corner post applicators (550). The corner post applicators (550) may apply/arrange corner posts (e.g., 555 of FIG. 5B) to the loaded pallet. A ready for stretch wrapping loaded pallet that includes a plurality of unit loads (557) on a pallet (270) strengthened via corner posts (555) is shown in FIG. 5B. The film applicator (530) may apply the wrapping film (e.g., from a loaded roll of film) to the loaded and strengthened pallet while the turntable (510) rotates to cause wrapping of the film around the loaded pallet. In some cases, the film applicator may include an arm that may move up and down to uniformly apply the film about a full height of the loaded pallet. Once wrapping of the film to the loaded pallet is completed, the wrapped loaded pallet may be provided/queued into the out-feed (575) and transported via, e.g., a conveyor mechanism or a forklift to a next production zone/line.

Disadvantages associated with operation and implementation of the prior art stretch wrapping station (500) of FIG. 5A may include added cost for charging/discharging of the loaded pallets onto/from the turntable (510), including, for example, added cost for a forklift and/or associated operator, or of a conveyor and queuing mechanism. Further added cost may include cost associated with acquisition and operation of the large size turntable (510) as well cost related to added footprint/space/area of the facility. As described below in the present disclosure, the bulk of the wrapping station (500) may be eliminated by deployment of the AMR (200) according to the present disclosure.

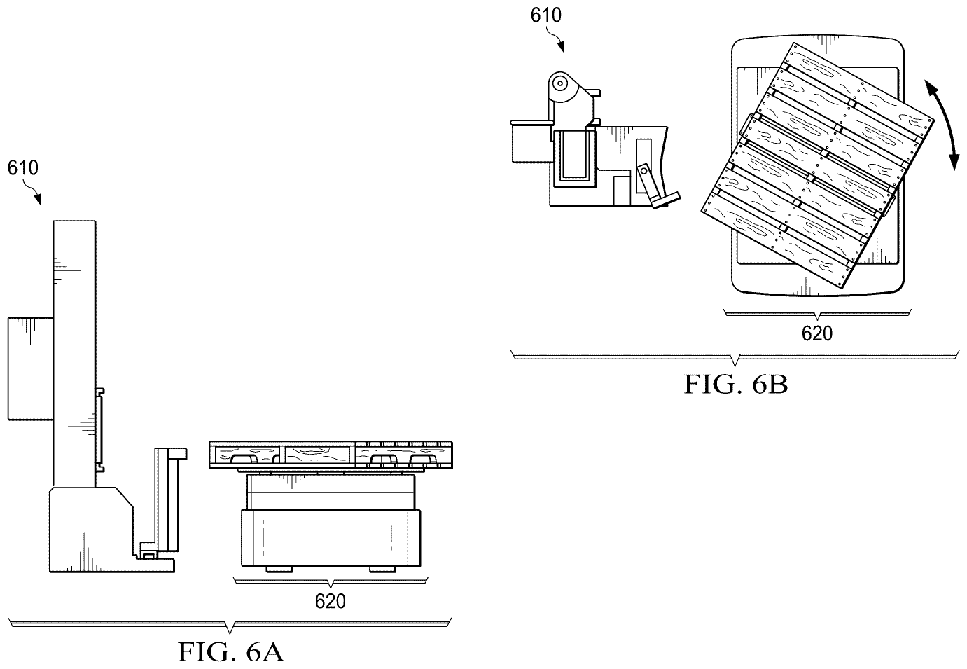

As previously described in the present disclosure, rotational control (e.g., angular position control) of the support table (240), combined with the vertical lift (e.g., vertical position control) of the support table (240) and navigation capabilities, provided by the AMR (200) according to the present teachings may enable new machine-to-machine interfaces not only to streamline, for example, the stretch wrapping process, but also reduce cost and space allocation. One exemplary embodiment according to the present disclosure of a new machine-to-machine interface for use in a production facility (e.g., 100 of FIG. 1) is shown in (side view of) FIG. 6A and (top view of) FIG. 6B. Shown in FIGS. 6A/6B is an interface/interaction of the AMR (200) according to the present teachings with an applicator (610) according to the present teachings. According to an embodiment of the present disclosure, the applicator (610) may be a label applicator, a film (e.g., wrapping film/sheet/material) applicator, a corner post applicator, or a combined film and corner post applicator. It should be noted that details of the applicator (610) beyond its functionality are not the subject of the present disclosure.

The AMR (200) loaded with a pallet (270) that may include unit loads (e.g., 557 of FIG. 5B) may be deployed for application of wrapping film and/or corner posts by the applicator (610). Loading of the pallet (270), including of the unit loads (e.g., 557 of FIG. 5B), may be performed at one or more pickup/loading zones/stations within the production facility (e.g., 100 of FIG. 1). Once the loading of the pallet (270) is completed, and as shown in FIG. 6A, the (loaded) AMR (200) may travel to and position itself at a docking location/point (620) corresponding to the applicator (610) and according to an orientation required by the docking location/point (620). As shown in FIG. 6A, during the travel and upon arrival to the docking location/point (620), the support table (240) of the AMR (200) may be lowered and set to an angular position of, e.g., zero degrees, such to produce a reduced profile of the (loaded) AMR (200) and support table (240) and increase stability of the load. Furthermore, once the AMR (200) achieves the prerequisite orientation at the docking location/point (620), it may engage its brakes (i.e., comprised in the base transport unit 210) for increased stability and position accuracy during the processing/application by the applicator (610).

As shown in FIG. 6B, once the AMR (200) is docked at the docking location/point (620), the support table (240), and therefore the loaded pallet (270), may rotate for processing/application by the applicator (610). For example, in a case of application of the corner posts (e.g., 555 of FIG. 5B), the AMR (200) may control the angular position of the support table (240) to four distinct (e.g., quadrature) positions for sequential application of the corner posts during (rest at) each of the four distinct positions. On the other hand, in a case of application of wrapping film, the AMR (200) may control a rotation speed and a number of revolutions of the support table (240) for uniform application of the wrapping film around the loaded support table (240). According to an embodiment of the present disclosure, the rotation speed of the support table (240) during the wrapping of the film may be according to a profile that may take into consideration any potential increase and/or decrease in resistance presented by the loaded support table (240) as the wrapping progresses. Such profile and/or the number of revolutions of the support table (240) may further take into consideration, for example, total weight of the loaded pallet and/or distribution of unit loads (e.g., 557 of FIG. 5B) across the width and/or height of the loaded pallet. Once the loaded pallet (270) is processed by the applicator (610), the AMR (200) may prepare for travel to a drop-off location of the loaded (and processed) pallet (270), including lowering of the support table (240) if necessary and restoring a nominal angular position (e.g., zero degrees) of the support table (240) such to produce a reduced profile of the (loaded) AMR (200).

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The references in the present application, shown in the reference list below, are incorporated herein by reference in their entirety.

1. An item transport vehicle, comprising:
a base transport unit comprising an autonomous mobile robot;
lift control elements and support elements arranged on the autonomous mobile robot; and
a support table resting on the support elements,
the lift control elements configured to raise and/or lower the support table, and
the support elements configured to rotate the support table to control an angular position of the support table.

2. The transport vehicle of claim 1, further comprising:
stability control elements arranged atop the autonomous mobile robot,
the stability control elements configured to stabilize a radial position of the support elements.

3. The transport vehicle of claim 2, further comprising:
a base plate, the lift control elements mounted on the base plate; and
a top plate, the support elements mounted on the top plate,
the top plate coupled to the base plate via the stability control elements,
the stability control elements restricting a relative motion of the top plate relative to the base plate to a vertical motion provided by the lift control elements.

4. The transport vehicle of claim 3, wherein:
each of the stability control elements comprises a top block, a bottom block, a top arm, and a bottom arm,
the top block and the bottom block respectively fixated to the top plate and the base plate,
respective first ends of the top arm and the bottom arm coupled to one another through a center pivot point, and
respective second ends of the top arm and the bottom arm respectively coupled to the top block and the bottom block through respective top and bottom pivot points.

5. The transport vehicle of claim 4, wherein:
for each of the stability control elements, respective rotation axes of the center, top and bottom pivot points are according to a same direction, and
arrangement of the stability control elements on the base plate is configured to provide at least two different directions of the respective rotation axes.

6. The transport vehicle of claim 1, wherein:
each of the lift control elements comprises a vertical lift structure coupled to a respective lift drive.

7. The transport vehicle of claim 6, wherein:
the vertical lift structure comprises a scissors mechanism coupled to the respective lift drive via a leadscrew.

8. (canceled)

9. The transport vehicle of claim 3, wherein:
the support elements are mounted through openings formed in the top plate.

10. The transport vehicle of claim 9, wherein:
the openings are formed according to locations of a circle centered about a center axis of the support table.

11. The transport vehicle of claim 3, wherein:
respective centers of the base plate and top plate coincide with a center axis of the support table.

12.-15. (canceled)

16. The transport vehicle of claim 1, wherein:
each of the support elements is configured to rotate about a respective rotation axis that intersects a center axis of the support table.

17. The transport vehicle of claim 3, further comprising:
at least one rotation drive for driving of at least one of the support elements, the at least one rotation drive mounted on a bottom surface of the top plate.

18.-19. (canceled)

20. The transport vehicle of claim 3, wherein:
the support table is coupled to the top plate via a bearing having a center that coincides with a center axis of the support table.

21. (canceled)

22. The transport vehicle of claim 1, wherein:
the support elements include at least one actively driven support element and at least one passive support element that is not actively driven.

23. The transport vehicle of claim 22, wherein:
the at least one actively driven support element rotates the support table via a friction force, and
the at least one passive support element guides a rotation of the support table.

24. An upgrade kit for a transport vehicle, comprising:
lift control elements, support elements, and
a support table resting on the support elements,
the lift control elements configured to raise and/or lower the support table to control a vertical position of the support table, and
the support elements configured to rotate the support table to control an angular position of the support table.

25. The upgrade kit of claim 24, further comprising:
stability control elements,
the stability control elements configured to stabilize a radial position of the support elements.

26. The upgrade kit of claim 25, further comprising:
a base plate, the lift control elements mounted on the base plate; and
a top plate, the support elements mounted on the top plate,
the top plate coupled to the base plate via the stability control elements,
the stability control elements restricting a relative motion of the top plate relative to the base plate to a vertical motion provided by the lift control elements.

27. The upgrade kit of claim 26, wherein:
the upgrade kit is configured to
be mounted atop a readily available autonomous mobile robot via a matching profile of the base plate, and
communicate with the autonomous mobile robot via control electronics included in the upgrade kit.

28. A method for loading and wrapping items, the method comprising:
providing an item transport vehicle comprising an autonomous mobile robot, lift control elements and support elements arranged atop the autonomous mobile robot, and a support table that rests on the support elements;
at an item loading station,
a) activating the lift control elements to control a vertical position of the support table by raising and/or lowering the support table, and/or
b) activating the support elements to control an angular position of the support table by rotating the support table, to load items on the support table;
deploying the item transport vehicle from the item loading station to a stretch wrapping applicator station; and
at the stretch wrapping applicator station,
activating the support elements to control a rotation speed of the support table, thereby stretch wrapping a film from the stretch wrapping applicator station around the items on the support table.

29.-38. (canceled)
